(19) United States
(12) Patent Application Publication
(10) Pub. No.: US 2022/0033301 A1
(43) Pub. Date: Feb. 3, 2022

(54) GLASS EDGE TREATMENT APPARATUS AND METHODS

(71) Applicant: CORNING INCORPORATED, CORNING, NY (US)

(72) Inventors: Michael Albert Joseph, II, Corning, NY (US); Jason Scott Stewart, Hornell, NY (US); Siva Venkatachalam, Horseheads, NY (US)

(21) Appl. No.: 17/275,265

(22) PCT Filed: Sep. 12, 2019
(86) PCT No.: PCT/US2019/050726

§ 371 Date: Mar. 11, 2021

Related U.S. Application Data
(60) Provisional application No. 62/731,185, filed on Sep. 14, 2018.

(51) Int. Cl. C03C 23/00

(52) U.S. Cl. CPC C03C 23/0075; C03B 17/064

(57) ABSTRACT

A glass treatment apparatus comprises an upstream applicator comprising a first surface. The first surface is movable between a first upstream position where the first surface is within a travel path of the glass treatment apparatus while extending across a travel direction of the travel path and facing a downstream direction opposite the travel direction, and a second upstream position where the first surface is outside the travel path. Additionally, methods of treating a glass ribbon with the glass treatment apparatus are disclosed.

### CROSS-REFERENCE TO RELATED APPLICATIONS

This application claims the benefit of priority to U.S. Provisional Application Ser. No. 62/731,185 filed on Sep. 14, 2018 the contents of which are relied upon and incorporated herein by reference in their entirety as if fully set forth below.

### FIELD

The present disclosure relates generally to methods for treating a glass ribbon and, more particularly, to methods for treating a glass ribbon with a glass treatment apparatus comprising one or more applicators.

### BACKGROUND

It is known to treat a glass ribbon with an acid to reduce unwanted particles. These unwanted particles may form at one or more edges of the glass ribbon during the glass manufacturing process. Additionally, the unwanted particles may also migrate to the glass surface causing surface quality issues. Inconsistencies in treatment may arise due to the glass ribbon being immersed in the acid. In addition, the acid may lead to a shortened lifespan of some equipment.

### SUMMARY

The following presents a simplified summary of the disclosure to provide a basic understanding of some embodiments described in the detailed description.

In accordance with some embodiments, a glass treatment apparatus can comprise an upstream applicator that can comprise a first surface. The first surface can be movable between a first upstream position where the first surface can be within a travel path of the glass treatment apparatus while extending across a travel direction of the travel path and facing a downstream direction opposite the travel direction, and a second upstream position where the first surface can be outside the travel path.

In some embodiments, the first surface of the upstream applicator can be rotatable between the first upstream position and the second upstream position.

In some embodiments, the glass treatment apparatus can further comprise a downstream applicator that can comprise a second surface. The second surface can be movable between a first downstream position where the second surface can be within the travel path while extending across the travel direction of the travel path and facing an upstream direction in the travel direction, and a second downstream position that can be outside the travel path.

In some embodiments, the second surface of the downstream applicator can be rotatable between the first downstream position and the second downstream position.

In some embodiments, the first surface of the upstream applicator can be parallel with the second surface of the downstream applicator.

In some embodiments, a glass treatment apparatus can comprise a downstream applicator that can comprise a second surface. The second surface can be movable between a first downstream position where the second surface can be within a travel path of the glass treatment apparatus while extending across a travel direction of the travel path and facing an upstream direction in the travel direction, and a second downstream position that can be outside the travel path.

In some embodiments, the second surface of the downstream applicator can be rotatable between the first downstream position and the second downstream position.

In some embodiments, the glass treatment apparatus can comprise a lateral applicator.

In some embodiments, the lateral applicator can comprise a channel facing a lateral direction extending across the travel direction.

In some embodiments, the lateral applicator can comprise a lateral surface rotatable about a rotation axis.

In some embodiments, the lateral applicator can comprise a lateral surface facing a lateral direction extending across the travel direction and parallel to the second surface of the downstream applicator.

In some embodiments, methods of forming a glass ribbon with the glass treatment apparatus can comprise moving a glass ribbon along the travel direction of the travel path. Methods can comprise applying an upstream treatment liquid to an upstream edge of the glass ribbon by engaging the upstream edge with the first surface of the upstream applicator positioned in the first upstream position. Methods can comprise moving the upstream applicator to the second upstream position. Methods can comprise continuing to move the glass ribbon along the travel direction of the travel path without engaging the glass ribbon with the first surface of the upstream applicator while the upstream applicator can be positioned in the second upstream position.

In some embodiments, methods can further comprise rotating the first surface from the second upstream position to the first upstream position during or prior to the applying the upstream treatment liquid.

In some embodiments, methods can further comprise rotating the first surface of the upstream applicator from the first upstream position to the second upstream position during the moving the upstream applicator to the second upstream position.

In some embodiments, methods can further comprise applying a downstream treatment liquid to a downstream edge of the glass ribbon by engaging the downstream edge with the second surface of the downstream applicator positioned in the first downstream position.

In some embodiments, methods can further comprise moving the second surface from the second downstream position to the first downstream position during or prior to the applying the downstream treatment liquid.

In some embodiments, methods can further comprise rotating the second surface of the downstream applicator from the second downstream position to the first downstream position during the moving the second surface from the second downstream position to the first downstream position.

In some embodiments, the moving the second surface from the second downstream position to the first downstream position can cause the upstream edge of the glass ribbon to engage the first surface of the upstream applicator positioned in the first upstream position such that the first surface applies the upstream treatment liquid to the upstream edge of the glass ribbon.

In some embodiments, methods of treating a glass ribbon with the glass treatment apparatus can comprise applying a downstream treatment liquid to a downstream edge of the glass ribbon by engaging the downstream edge with the second surface of the downstream applicator positioned in the first downstream position.

In some embodiments, methods can comprise moving the second surface from the second downstream position to the first downstream position during or prior to the applying the downstream treatment liquid.

In some embodiments, methods can comprise rotating the second surface of the downstream applicator from the second downstream position to the first downstream position during the moving the second surface from the second downstream position to the first downstream position.

In some embodiments, methods can comprise applying a lateral treatment liquid to one or more of a first lateral edge or a second lateral edge while moving the glass ribbon in the travel direction.

In some embodiments, the applying the lateral treatment liquid to one or more of the first lateral edge or the second lateral edge can comprise guiding the lateral treatment liquid to flow along a lateral surface facing a lateral direction extending across the travel direction and parallel to the second surface of the downstream applicator.

In some embodiments, one or more of the upstream treatment liquid, the downstream treatment liquid, or the lateral treatment liquid can comprise one or more of hydrofluoric acid or hydrochloric acid.

### BRIEF DESCRIPTION OF THE DRAWINGS

These and other features, embodiments and advantages are better understood when the following detailed description is read with reference to the accompanying drawings, in which:

FIG. 1 schematically illustrates a glass manufacturing apparatus in accordance with embodiments of the disclosure;

FIG. 2 shows a perspective cross-sectional view of the glass manufacturing apparatus along line 2-2 of FIG. 1 in accordance with embodiments of the disclosure;

FIG. 3 illustrates an end view of some embodiments of a glass treatment apparatus in accordance with embodiments of the disclosure;

FIG. 4 illustrates a top view of some embodiments of the glass treatment apparatus along line 4-4 of FIG. 3 in accordance with embodiments of the disclosure;

FIG. 5 illustrates an end view of some embodiments of the glass treatment apparatus comprising an upstream applicator in a first upstream position in accordance with embodiments of the disclosure;

FIG. 6 illustrates an end view of some embodiments of the glass treatment apparatus comprising a downstream applicator in a first downstream position in accordance with embodiments of the disclosure;

FIG. 7 illustrates an end view of some embodiments of the glass treatment apparatus comprising the upstream applicator in a second upstream position and the glass ribbon moving relative to the glass treatment apparatus in accordance with embodiments of the disclosure;

FIG. 8 illustrates an end view of some embodiments of the glass treatment apparatus comprising the downstream applicator in a second downstream position and the glass ribbon moving relative to the glass treatment apparatus in accordance with embodiments of the disclosure;

FIG. 9 illustrates a top view of some embodiments of the glass treatment apparatus in which an upstream edge of the glass ribbon may be non-parallel to the upstream applicator in accordance with embodiments of the disclosure;

FIG. 10 illustrates a top view of some embodiments of the glass treatment apparatus in which the upstream edge of the glass ribbon may be parallel to the upstream applicator in accordance with embodiments of the disclosure;

FIG. 11 illustrates a perspective view of some embodiments of a lateral applicator of the glass treatment apparatus in accordance with embodiments of the disclosure;

FIG. 12 illustrates a perspective view of additional embodiments of the lateral applicator of the glass treatment apparatus in accordance with embodiments of the disclosure; and

FIG. 13 illustrates a perspective view of yet additional embodiments of the lateral applicator of the glass treatment apparatus in accordance with embodiments of the disclosure.

### DETAILED DESCRIPTION

Embodiments will now be described more fully hereinafter with reference to the accompanying drawings in which embodiments are shown. Whenever possible, the same reference numerals are used throughout the drawings to refer to the same or like parts. However, this disclosure may be embodied in many different forms and should not be construed as limited to the embodiments set forth herein.

It may be understood that specific embodiments disclosed herein are intended to be exemplary and therefore non-limiting. For purposes of the disclosure, in some embodiments, a glass manufacturing apparatus can comprise a glass forming apparatus that forms a glass article (e.g., a glass ribbon) from a quantity of molten material. For example, in some embodiments, the glass manufacturing apparatus can comprise a glass forming apparatus such as a slot draw apparatus, float bath apparatus, down-draw apparatus, up-draw apparatus, press-rolling apparatus, or other glass forming apparatus that forms a glass article. In some embodiments, the glass article can be employed in a variety of display applications comprising, but not limited to, liquid crystal displays (LCDs), electrophoretic displays (EPD), organic light emitting diode displays (OLEDs), plasma display panels (PDPs), and other electronic displays.

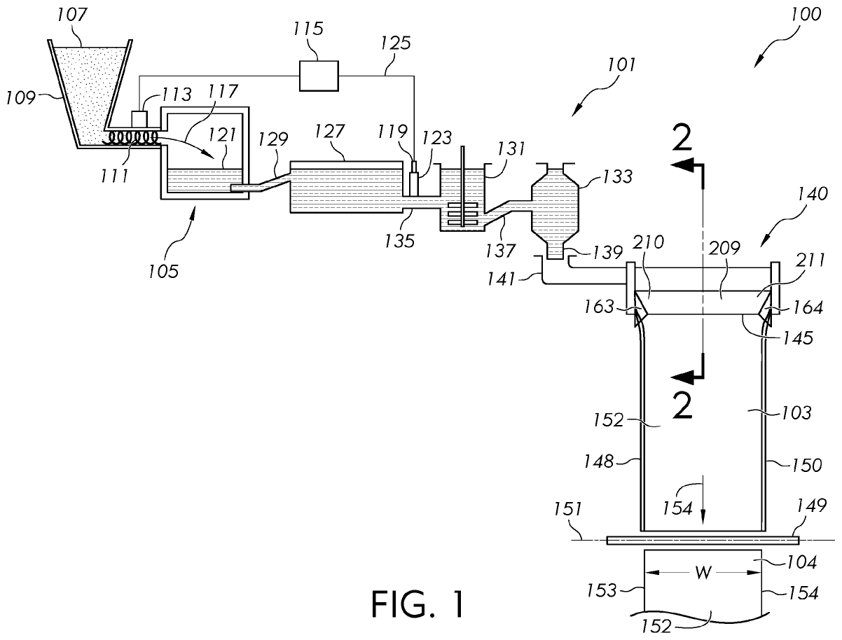

The present disclosure relates to a glass treatment apparatus and methods for treating a glass ribbon. Methods and apparatus for treating glass will now be described by way of embodiments for forming a glass ribbon from a quantity of molten material. As schematically illustrated in FIG. 1, in some embodiments, a glass manufacturing apparatus 100 can comprise a glass forming apparatus 101 comprising a forming vessel 140 designed to produce a glass ribbon 103 from a quantity of molten material 121. In some embodiments, the glass ribbon 103 can comprise a central portion 152 disposed between opposite, thick edge beads formed along a first lateral edge 148 and a second lateral edge 150 of the glass ribbon 103. Additionally, in some embodiments, a glass ribbon 104 can be separated from the glass ribbon 103 along a separation path 151 by a glass separator 149 (e.g., scribe, score wheel, diamond tip, laser, etc.). In some embodiments, before or after separation of the glass ribbon 104 from the glass ribbon 103, the thick edge beads formed along the first lateral edge 148 and the second lateral edge 150 can be removed to provide the central portion 152 as a high-quality glass ribbon 104 having a uniform thickness. As shown in FIG. 1, embodiments of the separated glass ribbon 104 can include the central portion 152 with a first lateral edge 153 and a second lateral edge 155 remaining after the thick edge beads have been removed.

In some embodiments, the glass manufacturing apparatus 100 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 100 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 100 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass manufacturing apparatus 100 can comprise a third conditioning station comprising a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 to the inlet conduit 141 of the forming vessel 140.

Various embodiments of forming vessels can be provided in accordance with features of the disclosure comprising a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a root 145 of a forming wedge 209 to produce a ribbon of molten material 121 that can be drawn into the glass ribbon 103. For example, in some embodiments, the molten material 121 can be delivered from the inlet conduit 141 to the forming vessel 140. The molten material 121 can then be formed into the glass ribbon 103 based at least in part on the structure of the forming vessel 140. For example, as shown, the molten material 121 can be drawn off the bottom edge (e.g., root 145) of the forming vessel 140 along a draw path extending in a draw direction 154 of the glass manufacturing apparatus 100. In some embodiments, edge directors 163, 164 can direct the molten material 121 off the forming vessel 140 into the glass ribbon 103 with the edge beads formed at the first lateral edge 148 and the second lateral edge 150 of the glass ribbon 103.

After separating the thick edge beads, as shown in FIG. 1, the separated glass ribbon 104 can include a width “W” that can extend between the first lateral edge 153 of the separated glass ribbon 104 and the second lateral edge 155 of the separated glass ribbon 104. In some embodiments, the width “W” of the separated glass ribbon 104 can be greater than or equal to about 20 millimeters (mm), such as greater than or equal to about 50 mm, such as greater than or equal to about 100 mm, such as greater than or equal to about 500 mm, such as greater than or equal to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the separated glass ribbon 104 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

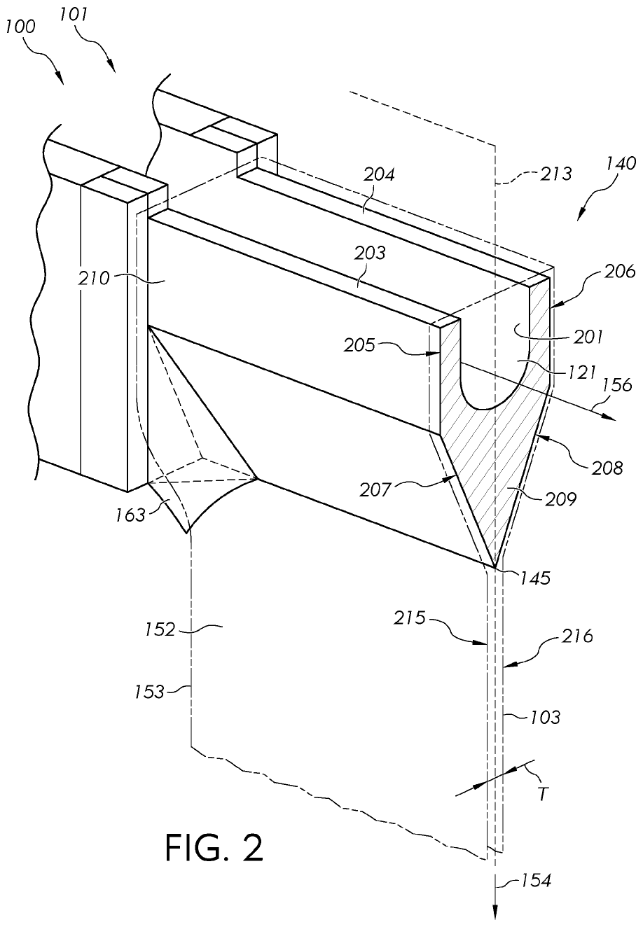

FIG. 2 shows a cross-sectional perspective view of the glass manufacturing apparatus 100 along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the draw direction 154 to intersect along a bottom edge of the forming wedge 209 to define the root 145 of the forming vessel 140. A draw plane 213 of the glass manufacturing apparatus 100 can extend through the root 145 along the draw direction 154. In some embodiments, the glass ribbon 103 can be drawn in the draw direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 to be drawn off the root 145 of the forming vessel 140, where the flows converge and fuse into the glass ribbon 103. The glass ribbon 103 can then be fusion drawn off the root 145 in the draw plane 213 along the draw direction 154. In some embodiments, the glass separator 149 (see FIG. 1) can then subsequently separate the glass ribbon 104 from the glass ribbon 103 along the separation path 151. In some embodiments, the separation path 151 can extend across (e.g., perpendicular to) the draw direction 154 of the glass ribbon 103 between the first lateral edge 148 and the second lateral edge 150 of the glass ribbon 103. Moreover, in some embodiments, the draw direction 154 can define a direction along which the glass ribbon 103 can be fusion drawn from the forming vessel 140. In some embodiments, the glass ribbon 103 can comprise a speed as it traverses along draw direction 154 of ≥50 mm/s, ≥100 mm/s, or ≥500 mm/s, for example, from about 50 mm/s to about 500 mm/s, such as from about 100 mm/s to about 500 mm/s, and all ranges and subranges therebetween.

As shown in FIG. 2, the glass ribbon 103 can be drawn from the root 145 with a first major surface 215 of the glass ribbon 103 and a second major surface 216 of the glass ribbon 103 facing opposite directions and defining a thickness “T” (e.g., average thickness) of the glass ribbon 103. In some embodiments, the thickness “T’ of the glass ribbon 103 can be less than or equal to about 2 mm, less than or equal to about 1 mm, less than or equal to about 0.5 mm, for example, less than or equal to about 300 micrometers (μm), less than or equal to about 200 μm, or less than or equal to about 100 μm, although other thicknesses may be provided in further embodiments. For example, in some embodiments, the thickness “T’ of the glass ribbon 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass ribbon 103 can comprise a variety of compositions including, but not limited to, soda-lime glass, borosilicate glass, alumino-borosilicate glass, alkali-containing glass, or alkali-free glass.

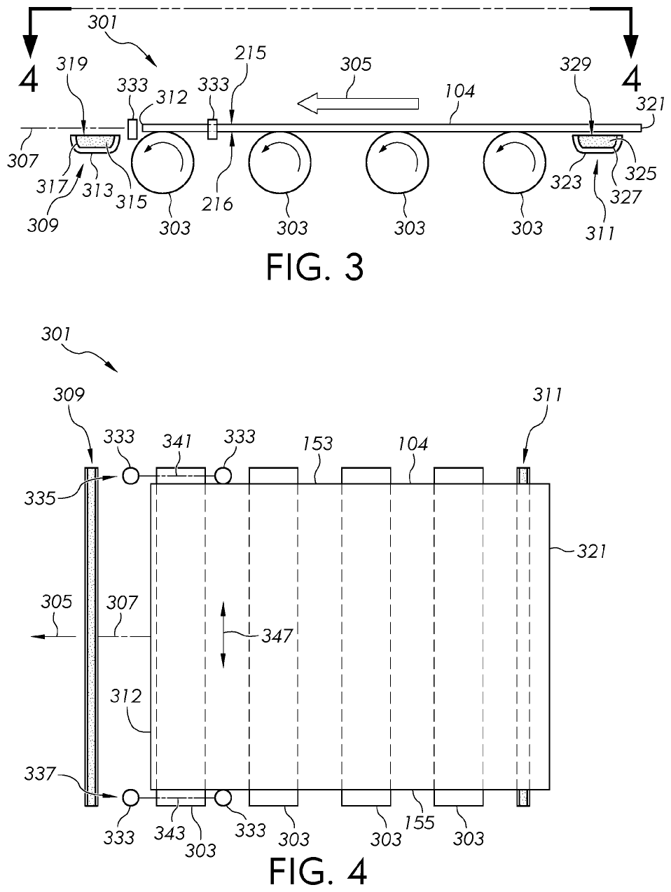

FIGS. 3-4 illustrate some embodiments of a glass treatment apparatus 301. FIG. 3 illustrates a side view of the glass treatment apparatus 301 while FIG. 4 illustrates a top view of the glass treatment apparatus 301 along line 4-4 of FIG. 3. In some embodiments, the glass treatment apparatus 301 is disposed downstream from the forming apparatus 101. As such, in some embodiments, the glass treatment apparatus 301 may be provided as a downstream processing station of the glass manufacturing apparatus 100 that is positioned downstream from the glass forming apparatus 101 that produces the separated glass ribbon 104. In alternative embodiments, the glass treatment apparatus 301 may treat glass ribbon 104 offsite. For example, a stack of glass ribbon 104 may be fed into the glass treatment apparatus 301 at a processing location (e.g., remote from the glass manufacturing apparatus 100) where further processing of the glass ribbon 104 is carried out. In further examples, a storage roll of glass ribbon may be uncoiled and separated into glass ribbon 104 of a desired length that can then be processed with the glass treatment apparatus 301.

In some embodiments, the glass treatment apparatus 301 assists in treating one or more edges of the glass ribbon 104. For example, the glass treatment apparatus 301 can treat one or more of an upstream edge 312, a downstream edge 321, the first lateral edge 153, or the second lateral edge 155 of the glass ribbon 104. In some embodiments, the treatment of the glass ribbon 104 by the glass treatment apparatus 301 may comprise applying a treatment liquid to one or more edges of the glass ribbon 104, which can reduce particles that may have accumulated at the edges of the glass ribbon 104. In some embodiments, these particles may comprise adhered glass particles that may be a product of a glass manufacturing process. For example, applying the treatment liquid to one or more edges of the glass ribbon 104 can reduce particles that may have accumulated at one or more of the edges 312, 321, 153, 155 of the separated glass ribbon 104 during a process of separating the glass ribbon 104 from the glass ribbon 103 and/or during a process of separating edge beads to produce the first and second lateral edge 153, 155 of the glass ribbon 104.

In some embodiments, methods of treating the glass ribbon 104 with the glass treatment apparatus 301 can comprise moving the glass ribbon 104 along a travel direction 305 of a travel path 307. In some embodiments, one or more rollers 303 can be provided to engage (e.g., physically contact) the glass ribbon 104 and convey the glass ribbon 104 along the travel path 307 in the travel direction 305. As shown, in some embodiments, the rollers 303, if provided, can be spaced apart from each other and can engage the second major surface 216 of the glass ribbon 104 although further embodiments may provide rollers that engage the first major surface 215 or rollers that engage both the first major surface 215 and the second major surface 216 of the glass ribbon 104. In some embodiments, one or more of the rollers 303 can be driven by a motor (not shown) to rotate (e.g., counter-clockwise in FIGS. 3 and 5-8), which can cause the glass ribbon 104 to move along the travel direction 305. In some embodiments, by engaging the first major surface 215 and/or the second major surface 216 of the glass ribbon 104, the rollers 303 can drive and/or steer the glass ribbon 104 along the travel path 307 in the travel direction 305.

In some embodiments, the glass treatment apparatus 301 comprises one or more of an upstream applicator 309 or a downstream applicator 311. The upstream applicator 309 may be located upstream from the downstream applicator 311 relative to the travel direction 305. In some embodiments, the upstream applicator 309 may extend in a direction that may be non-parallel to the travel direction 305 of the glass ribbon 104. For example, the upstream applicator 309 may extend perpendicular to the travel direction 305 of the glass ribbon 104. In some embodiments, a length of the upstream applicator 309 may be greater than the width “W” of the glass ribbon 104. In this way, the upstream applicator 309 can treat the entire upstream edge 312. In other embodiments, however, the upstream applicator 309 can have a length that may be less than the width “W” of the glass ribbon 104, such that the upstream applicator 309 can treat a portion of the upstream edge 312.

In some embodiments, the upstream applicator 309 comprises a material that can treat an upstream edge 312 of the glass ribbon 104 while avoiding unintended damage to the upstream edge 312. For example, the upstream applicator 309 may comprise a backing portion 313 and an engagement portion 315. The backing portion 313 may comprise a higher stiffness than the engagement portion 315, such that the backing portion 313 can reduce the likelihood of unintended flexing or bending of the upstream applicator 309. In some embodiments, the backing portion 313 may comprise various materials such as plastic (e.g., polypropylene), metal, or resin, although other materials may be employed to provide the desired level of stiffness.

The engagement portion 315 of the upstream applicator 309 may be attached to the backing portion 313. In some embodiments, the engagement portion 315 may comprise a material that can be more flexible than the backing portion 313. For example, the engagement portion 315 can comprise a flexible foam material (e.g., open-celled foam, closed-cell foam), bristles, pile fabric, fluoropolymers (e.g., polytetrafluoroethylene, polyvinylidene fluoride, etc.), fluoropolymer elastomer, polypropylene, or other materials that are flexible and can transfer liquid. In some embodiments, the backing portion 313 can define a channel 317 into which the engagement portion 315 can be received. The engagement portion 315 can be attached to the backing portion 313 in several ways, such as with adhesives, mechanical fasteners, etc. The engagement portion 315 may form a side of the upstream applicator 309 (e.g., a side that can selectively face the glass ribbon 104) while the backing portion 313 can form an opposing side of the upstream applicator 309. It will be appreciated that the attachment of the backing portion 313 and the engagement portion 315 may not be limited to the illustrated embodiments wherein the backing portion 313 can receive the engagement portion 315 within the channel 317. Rather, in some embodiments, the engagement portion 315 may be substantially hollow so as to define a longitudinal channel into which the backing portion 313 can be received. In some embodiments, the engagement portion 315 may comprise a hollow tube, for example, that can receive the backing portion 313.

In some embodiments, the upstream applicator 309 comprises a first surface 319. In some embodiments, the first surface 319 may be defined along the engagement portion 315, such that the engagement portion 315 can comprise the first surface 319. The upstream applicator 309 can be positioned to apply an upstream treatment liquid to the upstream edge 312 of the glass ribbon 104 by engaging the upstream edge 312 with the first surface 319 of the upstream applicator 309. In some embodiments, the first surface 319 can be substantially planar. In other embodiments, however, the first surface 319 may be non-planar (e.g., cylindrical), such as when the engagement portion 315 may be hollow and can receive the backing portion 313 within a channel.

Further referring to FIG. 3, the downstream applicator 311 may be located downstream from the upstream applicator 309 relative to the travel direction 305. In some embodiments, the downstream applicator 311 may extend in a direction that can be non-parallel to the travel direction 305 of the glass ribbon 104. For example, the downstream applicator 311 may extend perpendicular to the travel direction 305 of the glass ribbon 104. In some embodiments, a length of the downstream applicator 311 may be greater than the width “W” of the glass ribbon 104. In this way, the downstream applicator 311 can treat the entire downstream edge 321 of the glass ribbon 104. In other embodiments, however, the downstream applicator 311 can have a length that may be less than the width “W” of the glass ribbon 104, such that the downstream applicator 311 can treat a portion of the downstream edge 321. In some embodiments, the first surface 319 of the upstream applicator 309 may be parallel with the second surface 329 of the downstream applicator 311.

The downstream applicator 311 may be similar in structure and function to the upstream applicator 309. For example, the downstream applicator 311 may comprise a material that can treat a downstream edge 321 of the glass ribbon 104 while avoiding unintended damage to the downstream edge 321. In some embodiments, the downstream applicator 311 may comprise a backing portion 323 and an engagement portion 325. The backing portion 323 may comprise a greater stiffness than the engagement portion 325, such that the backing portion 323 can reduce the likelihood of unintended flexing of the downstream applicator 311. In some embodiments, the backing portion 323 may comprise various materials such as plastic (e.g., polypropylene), metal, or resin, although other materials may be employed to provide the desired level of stiffness.

The engagement portion 325 of the downstream applicator 311 may be attached to the backing portion 323. In some embodiments, the engagement portion 325 may comprise a material that can be similar in structure and function to the engagement portion 315 of the upstream applicator 309, such as a material that may be more flexible than the backing portion 323. For example, the engagement portion 325 can comprise a flexible foam material (e.g., open-cell foam, closed-cell foam), bristles, pile fabric or other materials that are flexible and can transfer liquid. In some embodiments, the backing portion 323 can define a channel 327 into which the engagement portion 325 can be received. The engagement portion 325 can be attached to the backing portion 323 in several ways, such as with adhesives, mechanical fasteners, etc. The engagement portion 325 may form a side of the downstream applicator 311 (e.g., a side that can selectively face the glass ribbon 104) while the backing portion 323 can form an opposing side of the downstream applicator 311. It will be appreciated that the attachment of the backing portion 323 and the engagement portion 325 may not be limited to the illustrated embodiments wherein the backing portion 323 can receive the engagement portion 325 within the channel 327. Rather, in some embodiments, the engagement portion 325 may be substantially hollow so as to define a longitudinal channel into which the backing portion 323 can be received. In some embodiments, the engagement portion 325 may comprise a hollow tube, for example, that can receive the backing portion 323.

In some embodiments, the downstream applicator 311 comprises a second surface 329. In some embodiments, the second surface 329 may be defined along the engagement portion 325, such that the engagement portion 325 may comprise the second surface 329. The downstream applicator 311 can be positioned to apply a downstream treatment liquid to the downstream edge 321 of the glass ribbon 104 by engaging the downstream edge 321 with the second surface 329 of the downstream applicator 311. In some embodiments, the second surface 329 may be substantially planar. In other embodiments, however, the second surface 329 may be non-planar, such as when the engagement portion 325 may be hollow and can receive the backing portion 323 within a channel.

In some embodiments, the glass treatment apparatus 301 comprises one or more lateral applicator(s) 333 that can apply a lateral treatment liquid to the first lateral edge 153 and/or the second lateral edge 155 of the glass ribbon 104. In some embodiments, the one or more lateral applicator(s) 333 may be arranged as a first row of lateral applicators 335 spaced apart from one another along a first lateral path 341 that may be parallel to the travel path 307. The first row of lateral applicators 335 may comprise two lateral applicators 333 (e.g., as illustrated), although, one or more than two lateral applicator(s) 333 may be provided in further embodiments. In some embodiments, the one or more lateral applicator(s) 333 may be arranged as a second row of lateral applicators 337 spaced apart from one another along a second lateral path 343 that may be parallel to the travel path 307. The second row of lateral applicators 337 may comprise two lateral applicators 333 (e.g., as illustrated), although, one or more than two lateral applicators 333 may be provided in further embodiments.

In some embodiments, the first row of lateral applicators 335 may be positioned along the first lateral edge 153 of the glass ribbon 104, while the second row of lateral applicators 337 may be positioned along the second lateral edge 155 of the glass ribbon 104. The first row of lateral applicators 335 and the second row of lateral applicators 337 may be spaced a distance apart along a lateral direction 347 that can be substantially parallel to the upstream applicator 309 and/or the downstream applicator 311, and substantially perpendicular to the travel direction 305. In some embodiments, the first lateral path 341 may be parallel to the second lateral path 343, such that the first row of lateral applicators 335 may be parallel to the second row of lateral applicators 337. In some embodiments, the distance separating the first row of lateral applicators 335 and the second row of lateral applicators 337 may be equal to the width “W” of the glass ribbon 104 between the first lateral edge 153 and the second lateral edge 155. In other embodiments, the distance separating the first row of lateral applicators 335 and the second row of lateral applicators 337 may be non-constant and/or adjustable, such that the distance can be varied. In these embodiments, the first row of lateral applicators 335 and/or the second row of lateral applicators 337 can be attached to a track or other similar structure that can allow for movement along the lateral direction 347. Such adjustability may be desirable so as to accommodate mis-alignment of the glass ribbon 104 (e.g., when the upstream edge 312 of the glass ribbon 104 may not be parallel to the upstream applicator 309 and the downstream edge 321 of the glass ribbon 104 may not be parallel to the downstream applicator 311), size variations in the glass ribbon 104, or the like.

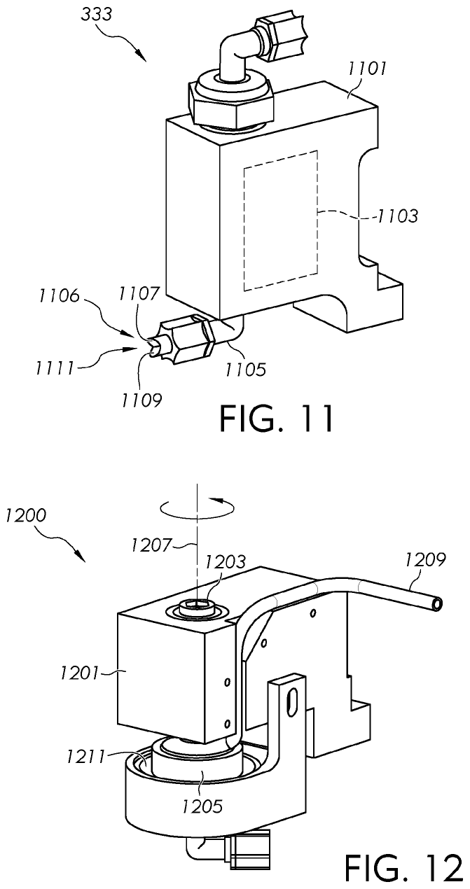

The structure and function of the lateral applicator 333 will described further relative to FIGS. 11-13. In some embodiments, the lateral applicator 333 comprises a channel facing the lateral direction 347 extending across the travel direction 305. In some embodiments, by extending across the travel direction 305, the lateral direction 347 can be orthogonal to the travel direction 305 and parallel to the first surface 319 of the upstream applicator 309 and/or the second surface 329 of the downstream applicator 311. In other embodiments, the lateral direction 347 is not limited to being orthogonal to the travel direction 305, and can extend at another angle (e.g., greater than or less than 90 degrees) relative to the travel direction 305. The lateral applicator 333 may comprise a lateral treatment liquid that can treat the first lateral edge 153 and/or the second lateral edge 155 of the glass ribbon 104 while avoiding unintended damage to the first lateral edge 153 and/or the second lateral edge 155. In some embodiments, one or more of the upstream treatment liquid, the downstream treatment liquid, or the lateral treatment liquid can comprise one or more of hydrofluoric acid, hydrochloric acid, sulfuric acid, a mixture of hydrofluoric acid and sulfuric acid, nitric acid, a mixture of hydrofluoric acid and nitric acid, ammonium bifluoride, buffered hydrofluoric acid, sodium fluoride, phosphoric acid, a mixture of sodium fluoride and phosphoric acid, potassium hydroxide, sodium hydroxide, or other solutions that can comprise one or more of these chemicals with other additives (e.g., surfactants, etc.). In other embodiments, one or more of the upstream treatment liquid, the downstream treatment liquid, or the lateral treatment liquid may comprise non-acid materials, such as cleaning materials, protective coatings, etc.

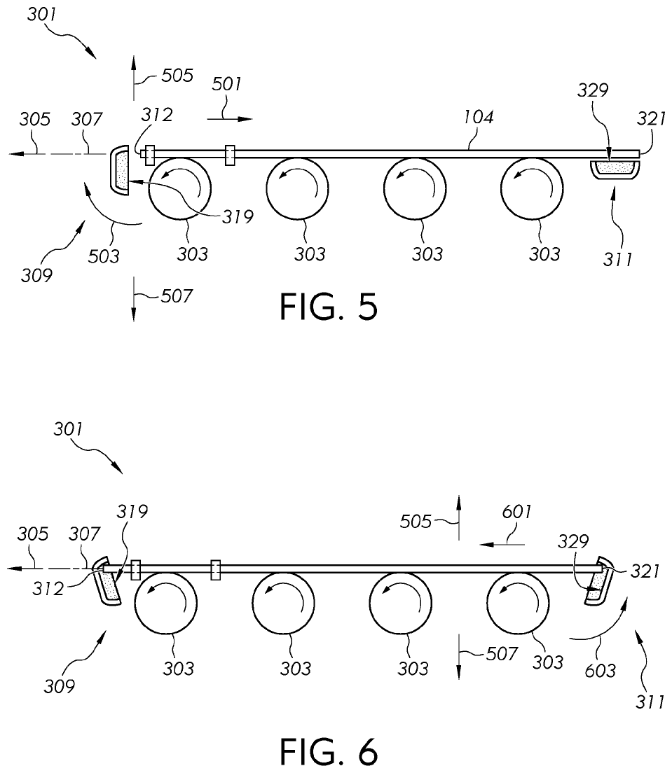

Referring to FIGS. 3-8, movement of the upstream applicator 309 between a first upstream position and a second upstream position is illustrated. In some embodiments, the first surface 319 may be movable between the first upstream position (e.g., illustrated in FIGS. 5-6) where the first surface 319 can be within the travel path 307 of the glass treatment apparatus 301 while extending across the travel direction 305 of the travel path 307 and facing a downstream direction 501 with a directional component that is opposite the travel direction 305, and the second upstream position (e.g., illustrated in FIGS. 3-4 and 7-8) where the first surface 319 can be outside the travel path 307. In some embodiments, the first surface 319 of the upstream applicator 309 and the second surface 329 of the downstream applicator 311 can extend across the travel direction 305 while lying within or outside the travel path 307. For example, in some embodiments, one or more of the upstream applicator 309 or the downstream applicator 311 can extend orthogonal to the travel direction 305, and may lie within the travel path 307, such that a plane defined by the glass ribbon 104 does intersect the first surface 319 of the upstream applicator 309 and/or the second surface 329 of the downstream applicator 311. In other embodiments, one or more of the upstream applicator 309 or the downstream applicator 311 can extend orthogonal to the travel direction 305, and may lie outside of the travel path 307, such that the plane defined by the glass ribbon 104 does not intersect the first surface 319 of the upstream applicator 309 and/or the second surface 329 of the downstream applicator 311. In some embodiments, the glass treatment apparatus 301 may comprise one or more gears, motors, actuators, or the like coupled to the upstream applicator 309 to move the upstream applicator 309 between the first upstream position and the second upstream position. In other embodiments, the upstream applicator 309 can be moved manually, such as by an operator, between the first upstream position and the second upstream position.

It will be appreciated that when the first surface 319 of the upstream applicator 309 is in the first upstream position (e.g., illustrated in FIGS. 5-6), the first surface 319 may lie within a plane defined by the glass ribbon 104, such that the plane defined by the glass ribbon 104 may intersect the first surface 319 of the upstream applicator 309. In some embodiments, the first surface 319 can face the upstream edge 312 of the glass ribbon 104, such that the upstream edge 312 may be in position to engage the first surface 319, such as by contacting the first surface 319. By facing the upstream edge 312 of the glass ribbon 104, the first surface 319 may or may not be parallel to the upstream edge 312. When the first surface 319 of the upstream applicator 309 is in the second upstream position (e.g., illustrated in FIGS. 3-4 and 7-8), the first surface 319 may be outside of the plane defined by the glass ribbon 104, such that the plane defined by the glass ribbon 104 does not intersect the first surface 319 of the upstream applicator 309. Thus, when the first surface 319 of the upstream applicator 309 is in the second upstream position, the glass ribbon 104 can be moved along the travel direction 305 of the travel path 307 without engaging the glass ribbon 104 with the first surface 319 of the upstream applicator 309.

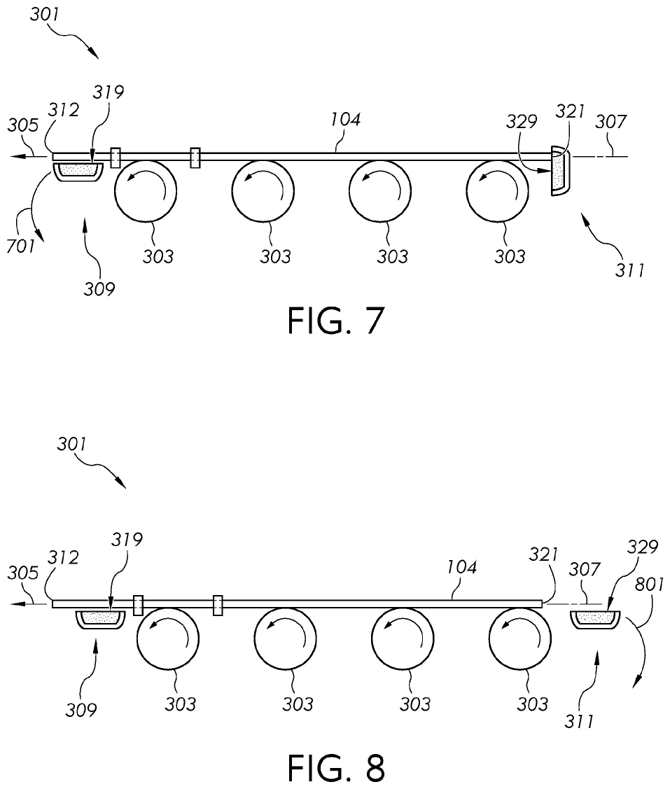

In some embodiments, movement of the first surface 319 of the upstream applicator 309 between the first upstream position and the second upstream position may comprise rotation about an axis. For example, the first surface 319 of the upstream applicator 309 may be rotatable between the first upstream position and the second upstream position. When rotating from the second upstream position to the first upstream position about an axis in a rotation direction 503 (e.g., from FIGS. 3-4 to FIG. 5), the first surface 319 of the upstream applicator 309 can rotate in the rotation direction 503 at least until the first surface 319 lies within the travel path 307 of the glass ribbon 104. By lying within the travel path 307 of the glass ribbon 104, the first surface 319 can lie within a plane defined by the glass ribbon 104, such that the plane defined by the glass ribbon 104 may intersect the first surface 319 of the upstream applicator 309. While the first upstream position of the first surface 319 can be about 90° offset from the first surface 319 in the second upstream position as illustrated, it will be appreciated that such a degree of offset is not intended to be limiting. Rather, in some embodiments, the upstream applicator 309 may rotate to a position in which the first surface 319 may lie within the travel path 307 of the glass ribbon 104, such as within a range of from about 30° to about 150° although other rotation angles in the rotation direction 503 of the upstream applicator from between the first upstream position and the second upstream position are also possible. The rotation angles (e.g., a range of from about 30° to about 150°) may be measured between the first upstream position of the first surface 319 and the second upstream position of the first surface 319. In further embodiments, the first surface 319 of the upstream applicator 309 can similarly be rotated about an axis of a rotation direction 701 (see FIG. 7) from the first upstream position (see FIG. 5-6) to the second upstream position (see FIG. 7).

It will be appreciated that movement of the first surface 319 of the upstream applicator 309 between the first upstream position and the second upstream position may not be limited to rotational movement. Rather, in some embodiments, the first surface 319 of the upstream applicator 309 can be moved, such as by sliding, along a first vertical direction 505 or a second vertical direction 507. In these embodiments, the first surface 319 can face the downstream direction 501 when the first surface 319 is in the first upstream position (e.g., illustrated in FIGS. 5-6) and the second upstream position. However, the first surface 319 may still be in the travel path 307 of the glass treatment apparatus 301 while in the first upstream position, and may lie outside the travel path 307 while in the second upstream position. In other embodiments, the first surface 319 of the upstream applicator 309 can be moved in other directions between the first upstream position and the second upstream position, such as by moving along a lateral direction (e.g., into and out of the page in FIG. 5).

Referring to FIGS. 5-8, movement of the downstream applicator 311 between a first downstream position and a second downstream position is illustrated. In some embodiments, the second surface 329 may be movable between a first downstream position (e.g., illustrated in FIGS. 6-7) where the second surface 329 can be within the travel path 307 of the glass treatment apparatus 301 while extending across the travel direction 305 of the travel path 307 and facing an upstream direction 601 with a directional component that is in the travel direction 305, and the second downstream position (e.g., illustrated in FIGS. 5 and 8) where the second surface 329 can be outside the travel path 307. In some embodiments, the glass treatment apparatus 301 may comprise one or more gears, motors, actuators, or the like coupled to the downstream applicator 311 to move the downstream applicator 311 between the first downstream position and the second downstream position. In other embodiments, the downstream applicator 311 can be moved manually, such as by an operator, between the first upstream position and the second upstream position.

When the second surface 329 of the downstream applicator 311 is in the first downstream position (e.g., illustrated in FIGS. 6 and 7), the second surface 329 may lie within a plane defined by the glass ribbon 104, such that the plane defined by the glass ribbon 104 may intersect the second surface 329 of the downstream applicator 311. When the second surface 329 of the downstream applicator 311 is in the first downstream position, the second surface 329 can face the downstream edge 321 of the glass ribbon 104, such that the downstream edge 321 may be in position to engage the second surface 329, such as by contacting the second surface 329. By facing the downstream edge 321 of the glass ribbon 104, the second surface 329 may or may not be parallel to the downstream edge 321.

It will be appreciated that when the second surface 329 of the downstream applicator 311 is in the second downstream position (e.g., illustrated in FIGS. 5 and 8), the second surface 329 may be outside of the travel path 307 of the glass ribbon 104, such that the travel path 307 of the glass ribbon 104 does not intersect the second surface 329 of the downstream applicator 311. Thus, when the second surface 329 of the downstream applicator 311 is in the second downstream position, the glass ribbon 104 can be moved along the travel direction 305 of the travel path 307 without engaging the glass ribbon 104 with the second surface 329 of the downstream applicator 311.

In some embodiments, by being movable between the first downstream position and the second downstream position, the second surface 329 of the downstream applicator 311 may be rotatable between the first downstream position and the second downstream position. For example, the movement of the second surface 329 of the downstream applicator 311 between the first downstream position and the second downstream position may comprise rotation about an axis. When rotating from the second downstream position to the first downstream position about an axis in a rotation direction 603 (e.g., see FIGS. 5-7), the second surface 329 of the downstream applicator 311 can rotate in the rotation direction 603 at least until the second surface 329 lies within the travel path 307 of the glass ribbon 104. By lying within the travel path 307 of the glass ribbon 104, the second surface 329 can lie within a plane defined by the glass ribbon 104, such that the plane defined by the glass ribbon 104 may intersect the second surface 329 of the downstream applicator 311. While the first downstream position of the second surface 329 can be about 80°-90° offset from the second surface 329 in the second downstream position, it will be appreciated that such a degree of offset is not intended to be limiting. Rather, in some embodiments, the downstream applicator 311 may rotate to a position in which the second surface 329 may lie within the travel path 307 of the glass ribbon 104, such as within a range of from about 30° to about 150° although other rotation angles in the rotation direction 603 of the downstream applicator 311 from between the second upstream position to the first upstream position are possible. The rotation angles (e.g., a range of from about 30° to about 150°) may be measured between the first downstream position of the second surface 329 and the second downstream position of the second surface 329. In this way, in some embodiments, methods of treating the glass ribbon 104 with the glass treatment apparatus 301 can comprise rotating the second surface 329 of the downstream applicator 311 from the second downstream position to the first downstream position while moving the second surface 329 from the second downstream position to the first downstream position.

It will be appreciated that the movement of the second surface 329 of the downstream applicator 311 between the first downstream position and the second downstream position may not be limited to rotational movement. Rather, in some embodiments, the second surface 329 of the downstream applicator 311 can be moved, such as by sliding, along the first vertical direction 505 or the second vertical direction 507. In these embodiments, the second surface 329 can face the upstream direction 601 when the second surface 329 is in the first downstream position (e.g., illustrated in FIGS. 6 and 7) and the second downstream position (e.g., illustrated in FIGS. 5 and 8). However, the second surface 329 may still be in the travel path 307 of the glass treatment apparatus 301 while in the first downstream position, and may lie outside the travel path 307 while in the second downstream position. In other embodiments, the second surface 329 of the downstream applicator 311 can be moved in other directions between the first downstream position and the second downstream position, such as by moving along a lateral direction (e.g., into and out of the page in FIG. 6).

In some embodiments, methods of treating the glass ribbon 104 with the glass treatment apparatus 301 can comprise applying a downstream treatment liquid to the downstream edge 321 of the glass ribbon 104 by engaging the downstream edge 321 with the second surface 329 of the downstream applicator 311 positioned in the first downstream position (see FIGS. 6 and 7). For example, as the second surface 329 moves (e.g., rotates) from the second downstream position (e.g., illustrated in FIG. 5) to the first downstream position (e.g., illustrated in FIGS. 6 and 7), the second surface 329 can engage the downstream edge 321 of the glass ribbon 104. The second surface 329 may be impregnated or coated with the downstream treatment liquid. In some embodiments, as the second surface 329 engages the downstream edge 321, the downstream treatment liquid can be applied to the downstream edge 321.

Engagement of the downstream edge 321 by the second surface 329 and application of the downstream treatment liquid to the downstream edge 321 may be beneficial in several ways. For example, the downstream treatment liquid can reduce particles, such as adhered glass particles, at the downstream edge 321 that may be a product of the glass manufacturing process. In addition or in the alternative, the second surface 329 can scrub the downstream edge 321 when the second surface 329 contacts and engages the downstream edge 321. In this way, application of the downstream treatment liquid and/or scrubbing of the downstream edge 321 can reduce particles and unintended scratches at the downstream edge 321. In some embodiments, the second surface 329 can apply a protective coating to the downstream edge 321 when the second surface 329 engages the downstream edge 321.

In some embodiments, methods of treating the glass ribbon 104 with the glass treatment apparatus 301 can comprise moving the second surface 329 from the second downstream position to the first downstream position during or prior to applying the downstream treatment liquid. For example, as illustrated in FIG. 6, as the second surface 329 rotates in the rotation direction 603 from the second downstream position to the first downstream position, the second surface 329 can engage the downstream edge 321. This engagement of the downstream edge 321 can cause application of the downstream treatment liquid to the downstream edge 321. In these embodiments, therefore, the second surface 329 can apply the downstream liquid during movement of the second surface 329 from the second downstream position to the first downstream position. In some embodiments, as the second surface 329 may be rotated in the rotation direction 603 from the second downstream position to the first downstream position, the second surface 329 may not engage the downstream edge 321. Rather, the downstream edge 321 may be spaced apart from the second surface 329 during movement of the second downstream position to the first downstream position. In some embodiments, the second surface 329 can engage the downstream edge 321 after the second surface 329 has been moved to the first downstream position, such as by the rollers 303 moving the glass ribbon 104 along the downstream direction 501 and into contact with the second surface 329. To move the glass ribbon 104 along the downstream direction 501, the rollers 303 can be rotated in a rotational direction that is opposite the rotational direction illustrated in FIGS. 3 and 5-8 (e.g., by rotating the rollers 303 in a clockwise direction to move the glass ribbon 104 along the downstream direction 501). Accordingly, in some embodiments, the second surface 329 can be moved from the second downstream position to the first downstream position prior to applying the downstream liquid to the downstream edge 321.

In some embodiments, moving the second surface 329 from the second downstream position to the first downstream position can cause the upstream edge 312 of the glass ribbon 104 to engage the first surface 319 of the upstream applicator 309 positioned in the first upstream position such that the first surface 319 applies the upstream treatment liquid to the upstream edge 312 of the glass ribbon 104. For example, with brief reference to FIG. 5, the first surface 319 of the upstream applicator 309 may initially be spaced a distance apart from the upstream edge 312 of the glass ribbon 104. The first surface 319 may therefore not initially engage the upstream edge 312. With reference to FIG. 6, as the second surface 329 moves (e.g., rotates) from the second downstream position to the first downstream position, the second surface 329 can engage the downstream edge 321 and apply a force to the downstream edge 321 in the upstream direction 601. This force applied by the second surface 329 can cause the glass ribbon 104 to move a distance in the upstream direction 601, whereupon the upstream edge 312 of the glass ribbon 104 can engage the first surface 319. In addition or alternatively, embodiments of the disclosure may comprise one or more driven rollers 303 that drive the glass ribbon 104 in the upstream direction 601 such that the upstream edge 312 engages the first surface 319 to scrub the upstream edge 312 and/or apply a liquid to the upstream edge 312.

In some embodiments, methods of treating the glass ribbon 104 with the glass treatment apparatus 301 can comprise applying the upstream treatment liquid to the upstream edge 312 of the glass ribbon 104 by engaging the upstream edge 312 with the first surface 319 of the upstream applicator 309 positioned in the first upstream position. For example, the first surface 319 may be impregnated or coated with the upstream treatment liquid. As the second surface 329 applies the force to the glass ribbon 104 to move the glass ribbon 104 in the upstream direction 601, the first surface 319 can engage the upstream edge 312 and the upstream treatment liquid can be applied to the upstream edge 312.

In some embodiments, engagement of the upstream edge 312 by the first surface 319 and application of the upstream treatment liquid to the upstream edge 312 may be beneficial in several ways. For example, the upstream treatment liquid can reduce particles, such as adhered glass particles, at the upstream edge 312 that may be a product of the glass manufacturing process. In addition or in the alternative, the first surface 319 can scrub the upstream edge 312 when the first surface 319 engages the upstream edge 312. In this way, application of the upstream treatment liquid and/or scrubbing of the upstream edge 312 can reduce particles and unintended scratches at the upstream edge 312. In some embodiments, the first surface 319 can apply a protective coating to the upstream edge 312 when the first surface 319 engages the upstream edge 312.

Referring to FIG. 7, after the upstream treatment liquid has been applied to the upstream edge 312 by the first surface 319 and the downstream treatment liquid has been applied to the downstream edge 321 by the second surface 329, methods of treating the glass ribbon 104 with the glass treatment apparatus 301 can comprise moving the upstream applicator 309 to the second upstream position. When the upstream applicator 309 is in the second upstream position, the first surface 319 may be outside of the travel path 307 of the glass ribbon 104, such that the travel path 307 of the glass ribbon 104 does not intersect the first surface 319 of the upstream applicator 309. The glass ribbon 104 can therefore be moved along the travel direction 305 of the travel path 307 without engaging the glass ribbon 104 with the first surface 319 of the upstream applicator 309. In some embodiments, methods of treating the glass ribbon 104 with the glass treatment apparatus 301 can comprise rotating the first surface 319 of the upstream applicator 309 about an axis in a rotation direction 701 from the first upstream position (e.g., see FIGS. 5-6) to the second upstream position (see FIGS. 7-8) while moving (e.g., rotating) the upstream applicator 309 to the second upstream position. The first surface 319 can rotate to the second upstream position such that the first surface 319 no longer lies within the travel path 307.

Referring to FIG. 8, after the first surface 319 has moved to the second upstream position, methods of treating the glass ribbon 104 with the glass treatment apparatus 301 can comprise continuing to move the glass ribbon 104 along the travel direction 305 of the travel path 307 without engaging the glass ribbon 104 with the first surface 319 of the upstream applicator 309 while the upstream applicator 309 remains in the second upstream position. For example, the rollers 303 can rotate (e.g., counter-clockwise in the illustrated embodiment) and convey the glass ribbon 104 along the travel path 307 in the travel direction 305. Since the first surface 319 can be in the second upstream position, movement of the glass ribbon 104 along the travel path 307 may not be impeded or prevented by the first surface 319 of the upstream applicator 309.

In some embodiments, methods of treating the glass ribbon 104 with the glass treatment apparatus 301 can comprise moving the downstream applicator 311 to the second downstream position. When the downstream applicator 311 is in the second downstream position, the second surface 329 is outside the travel path 307 of the glass ribbon 104, such that the travel path 307 of the glass ribbon 104 does not intersect the second surface 329 of the downstream applicator 311. In some embodiments, methods of treating the glass ribbon 104 with the glass treatment apparatus 301 can comprise rotating the second surface 329 of the downstream applicator 311 about an axis in a rotation direction 801 (see FIG. 8) from the first downstream position (see FIG. 7) to the second downstream position (see FIG. 8) while moving (e.g., rotating) the downstream applicator 311 to the second downstream position. The second surface 329 can rotate to the second downstream position such that the second surface 329 no longer lies within the travel path 307. With the downstream applicator 311 in the second downstream position, a second glass ribbon located downstream from the glass ribbon 104 can therefore be moved along the travel direction 305 of the travel path 307 without engaging the downstream applicator 311. The second glass ribbon can be moved to the position illustrated in FIG. 3, whereupon the glass treatment apparatus 301 can treat the edges of the second glass ribbon in a similar manner as described herein with respect to the glass ribbon 104.

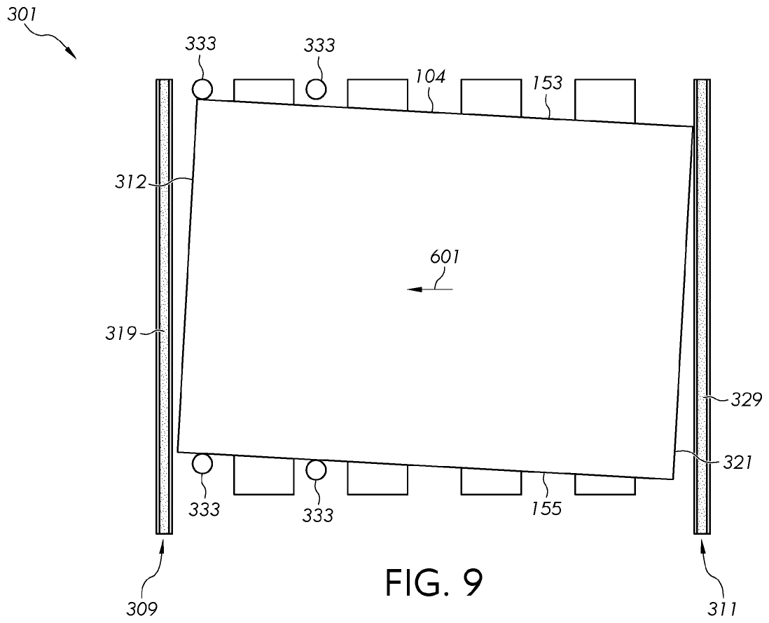

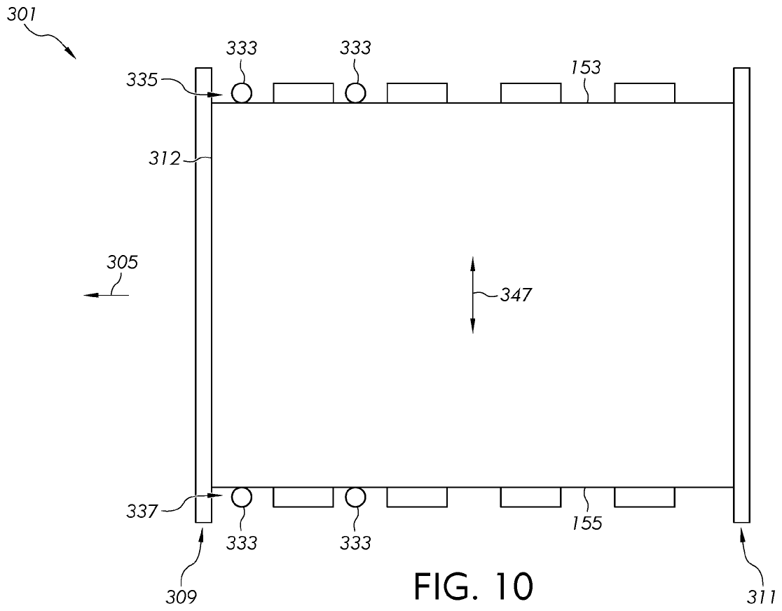

FIGS. 9-10 illustrate a top view of the glass ribbon 104 and the glass treatment apparatus 301. As illustrated in FIG. 9, in some embodiments, the glass ribbon 104 may initially be mis-aligned relative to the applicators 309, 311, 333. For example, initially, the upstream applicator 309 and the downstream applicator 311 may be in the second upstream position and the second downstream position (e.g., illustrated in FIG. 4). As the glass ribbon 104 moves along the travel direction 305 of the travel path 307, the glass ribbon 104 may be mis-aligned, such that the upstream edge 312 may be non-parallel to the upstream applicator 309 and/or the downstream edge 321 may be non-parallel to the downstream applicator 311. Such a misalignment may be undesirable since the applicators 309, 311, 333 may not adequately contact the upstream edge 312, the downstream edge 321, the first lateral edge 153, and/or the second lateral edge 155. As a result, the upstream treatment liquid, the downstream treatment liquid, and/or the lateral treatment liquid may not be adequately applied to the upstream edge 312, the downstream edge 321, the first lateral edge 153, and/or the second lateral edge 155.

To rectify this mis-alignment, in some embodiments, the upstream applicator 309 and the downstream applicator 311 can align the glass ribbon 104 relative to the glass treatment apparatus 301 such that the upstream edge 312 can be parallel to the upstream applicator 309 and the downstream edge 321 can be parallel to the downstream applicator 311. For example, the upstream applicator 309 can move from the second upstream position (e.g., illustrated in FIG. 3) to the first upstream position (e.g., illustrated in FIG. 5). With the upstream applicator 309 in the first upstream position that lies within the travel path 307, the downstream applicator 311 can move from the second downstream position (e.g., illustrated in FIG. 5) to the first upstream position (e.g., illustrated in FIG. 6). As the second surface 329 of the downstream applicator 311 engages the downstream edge 321 of the glass ribbon 104, the second surface 329 can apply a force to the downstream edge 321 along the upstream direction 601. This force can cause the upstream edge 312 of the glass ribbon 104 to engage the first surface 319 of the upstream applicator 309. As illustrated in FIG. 10, the first surface 319 and the second surface 329 can sandwich the glass ribbon 104 and align the glass ribbon 104 relative to the glass treatment apparatus 301. For example, with the glass ribbon 104 engaged by and sandwiched between the first surface 319 and the second surface 329, the upstream edge 312 of the glass ribbon 104 may be parallel to the first surface 319 of the upstream applicator 309 while the downstream edge 321 of the glass ribbon 104 may be parallel to the second surface 329 of the downstream applicator 311.

In some embodiments, with the glass ribbon 104 aligned relative to the glass treatment apparatus 301, methods of treating the glass ribbon 104 with the glass treatment apparatus 301 can comprise applying a lateral treatment liquid to one or more of the first lateral edge 153 or the second lateral edge 155 while moving the glass ribbon 104 in the travel direction 305. For example, once the glass ribbon 104 has been aligned, the upstream applicator 309 can be moved to the second upstream position and the downstream applicator 311 can be moved to the second downstream position. In this way, the upstream applicator 309 and the downstream applicator 311 may be out of the travel path 307 of the glass ribbon 104.

The first row of lateral applicators 335 may be positioned along the first lateral edge 153 of the glass ribbon 104 while the second row of lateral applicators 337 may be positioned along the second lateral edge 155 of the glass ribbon 104. In some embodiments, the first row of lateral applicators 335 can apply a lateral treatment liquid (e.g., a first lateral treatment liquid) to the first lateral edge 153 while the second row of lateral applicators 337 can apply the lateral treatment liquid (e.g., a second lateral treatment liquid) to the second lateral edge 155. The glass ribbon 104 can be moved in the travel direction 305 and/or opposite the travel direction 305, with the lateral treatment liquid being applied to the lateral edges 153, 155. In some embodiments, by moving in the travel direction 305 and opposite the travel direction 305, the rollers 303 can selectively rotate in a reciprocating manner, such as first rotating in a first rotational direction (e.g., counter-clockwise) and then rotating in a second rotational direction (e.g., clockwise). This reciprocating rotational movement can cause the glass ribbon 104 to move back and forth, such as in the upstream direction 601 followed by the downstream direction 501. In this way, the glass ribbon 104 can be repeatedly passed along the lateral applicators 333 at least until the first lateral edge 153 and the second lateral edge 155 of the glass ribbon 104 have been adequately treated.

Referring to FIG. 11, some embodiments of the least one lateral applicator 333 of the first row of lateral applicators 335 and/or the second row of lateral applicators 337 is illustrated. The lateral applicator 333 can be positioned along the glass ribbon 104, and can apply the lateral treatment liquid to the first lateral edge 153 and/or the second lateral edge 155 as the glass ribbon 104 moves in the travel direction 305. In some embodiments, the lateral applicator 333 can comprise a body 1101. The body 1101 can be substantially hollow and may define a reservoir 1103 that can store the lateral treatment liquid. In some embodiments, the body 1101 can define an inlet and an outlet that may be in fluid communication with the reservoir 1103. The reservoir 1103 can receive the lateral treatment liquid through the inlet and can dispense the lateral treatment liquid through the outlet. In some embodiments, the reservoir 1103 can be maintained at a low pressure, such as less than 1 pound per square inch, to facilitate flow of the lateral treatment liquid through the reservoir 1103.

In some embodiments, the lateral applicator 333 can comprise a conduit 1105 that may be attached to the outlet of the reservoir 1103. The conduit 1105 may comprise a tube, a pipe, a hose, a duct, or the like. In some embodiments, the conduit 1105 may be in fluid communication with the reservoir 1103, such that the conduit 1105 can receive the lateral treatment liquid from the reservoir 1103. The conduit 1105 can comprise a tip 1106 comprising first wall 1107 and a second wall 1109 that may be positioned at an end of the conduit 1105 opposite the body 1101. In some embodiments, the first wall 1107 and the second wall 1109 can be spaced apart to define a channel 1111. The lateral applicator 333 can comprise the channel 1111 facing the lateral direction 347 extending across the travel direction 305 (e.g., lateral direction 347 illustrated in FIGS. 4 and 10). In some embodiments, the channel 1111 may be sized to receive the first lateral edge 153 or the second lateral edge 155 of the glass ribbon 104, such that when the glass ribbon 104 moves in the travel direction 305, the first lateral edge 153 or the second lateral edge 155 can move within the channel 1111. In some embodiments, the channel 1111 can be sized to receive the glass ribbon 104 with the glass ribbon 104 comprising a thickness that may be less than or equal to about 0.7 mm. In some embodiments, the first wall 1107 and the second wall 1109 can comprise a flexible material that may reduce the risk of inadvertent damage to the first lateral edge 153 and the second lateral edge 155 if one of the lateral edges 153, 155 comes into contact with the first wall 1107 or the second wall 1109. For example, the first wall 1107 and the second wall 1109 can comprise a foam material, a porous polypropylene material, etc.

In some embodiments, the lateral treatment liquid can be applied as the first lateral edge 153 or the second lateral edge 155 pass between the first wall 1107 and the second wall 1109 without contacting the first wall 1107 and the second wall 1109. For example, the lateral treatment liquid can form a meniscus within the channel 1111 between the first wall 1107 and the second wall 1109, such that the first lateral edge 153 or the second lateral edge 155 can pass through the meniscus without contacting the first wall 1107 and the second wall 1109. In some embodiments, the first wall 1107 and the second wall 1109 may comprise a non-woven polytetrafluoroethylene material in addition to the foam and porous polypropylene material. In some embodiments, the tip 1106 can be removable and replaceable. For example, after a period of time in use, it may be desirable to replace the tip 1106 with a new tip.

In some embodiments, the tip 1106 can receive the lateral treatment liquid from the reservoir 1103 and through the conduit 1105. Due to the tip 1106 comprising the flexible and/or porous material, the tip 1106 can be impregnated with the lateral treatment liquid. In some embodiments, the channel 1111 can be at least partially filled with the lateral treatment liquid. As the glass ribbon 104 moves in the travel direction 305, the first lateral edge 153 or the second lateral edge 155 may be received within the channel 1111 and can move relative to the lateral applicator 333. Due to the channel 1111 being at least partially filled with the lateral treatment liquid, the first lateral edge 153 or the second lateral edge 155 can be coated with the lateral treatment liquid as the glass ribbon 104 moves relative to the lateral applicator 333. In some embodiments, the lateral treatment liquid can reduce particles, such as adhered glass particles, at the first lateral edge 153 or the second lateral edge 155 that may be a product of the glass manufacturing process. In other embodiments, the tip 1106 can scrub the first lateral edge 153 or the second lateral edge 155 as the glass ribbon 104 moves relative to the lateral applicator 333. In this way, application of the lateral treatment liquid and/or scrubbing of the first lateral edge 153 or the second lateral edge 155 can reduce particles and unintended scratches at the lateral edges 153, 155 of the glass ribbon 104.

Referring to FIG. 12, further embodiments of a lateral applicator 1200 of the first row of lateral applicators 335 and/or the second row of lateral applicators 337 is illustrated. In some embodiments, the lateral applicator 1200 can comprise a body 1201. The body 1201 can be at least partially hollow and may receive a shaft 1203. In some embodiments, the lateral applicator 1200 can comprise a lateral surface 1205 that may be rotatable about a rotation axis 1207. The lateral surface 1205 can be attached to the shaft 1203, such as by extending circumferentially around the shaft 1203. In some embodiments, the shaft 1203 can be rotatable about the rotation axis 1207, such that the lateral surface 1205 may likewise be rotatable about the rotation axis 1207. For example, in some embodiments, the lateral surface 1205 can comprise a roller. In some embodiments, the lateral surface 1205 can comprise a flexible material that may reduce the risk of inadvertent damage to the first lateral edge 153 and the second lateral edge 155. For example, the lateral surface 1205 can comprise a foam material, a porous polypropylene material, etc.

The lateral applicator 1200 can comprise a supply conduit 1209 that delivers the lateral treatment liquid to the lateral surface 1205. In some embodiments, due to the lateral surface 1205 comprising the flexible and/or porous material, the lateral surface 1205 can be impregnated with the lateral treatment liquid. The lateral applicator 1200 can comprise a collection reservoir 1211 that may be disposed below the shaft 1203 and the lateral surface 1205. In some embodiments, the collection reservoir 1211 can comprise a wall defining a reservoir. The collection reservoir 1211 can recapture at least some of the lateral treatment liquid from the shaft 1203, the lateral surface 1205, and/or the supply conduit 1209. For example, as the lateral treatment liquid drips from the shaft 1203, the lateral surface 1205, and/or the supply conduit 1209, the lateral treatment liquid falls into the collection reservoir 1211. In some embodiments, the lateral applicator 1200 can comprise a pump that can recirculate the collected lateral treatment liquid from the collection reservoir 1211 back to the supply conduit 1209.

As the glass ribbon 104 moves in the travel direction 305, the first lateral edge 153 or the second lateral edge 155 may contact and/or engage the lateral surface 1205 and can move relative to the lateral applicator 1200. Due to the lateral surface 1205 being impregnated and/or coated with the lateral treatment liquid from the supply conduit 1209, the first lateral edge 153 or the second lateral edge 155 can be coated with the lateral treatment liquid as the first lateral edge 153 or the second lateral edge 155 contacts the lateral surface 1205. In some embodiments, as the glass ribbon 104 moves relative to the lateral applicator 1200 and the first lateral edge 153 or the second lateral edge 155 engages the lateral surface 1205, the lateral surface 1205 can rotate about the rotation axis 1207. For example, the lateral surface 1205 and the shaft 1203 can rotate about the rotation axis 1207 due to engagement between the lateral edge 153, 155 and the lateral surface 1205. In some embodiments, the lateral surface 1205 and the shaft 1203 may be freely rotatable and may not be driven by an external source (e.g., a motor) such that movement of the glass ribbon 104 and engagement between the lateral edge 153, 155 and the lateral surface 1205 can cause rotation of the lateral surface 1205. In some embodiments, the lateral surface 1205 and the shaft 1203 can be rotated by an external source (e.g., a motor), such that the lateral surface 1205 can at least partially govern a speed at which the glass ribbon 104 moves (e.g., by increasing or decreasing the speed at which the lateral surface 1205 rotates). In some embodiments, the lateral treatment liquid applied by the lateral surface 1205 can reduce particles, such as adhered glass particles, at the first lateral edge 153 or the second lateral edge 155 that may be a product of the glass manufacturing process. In addition or in the alternative, contact between the lateral surface 1205 and the first lateral edge 153 or the second lateral edge 155 can scrub the first lateral edge 153 or the second lateral edge 155 as the glass ribbon 104 moves relative to the lateral applicator 1200. In this way, application of the lateral treatment liquid and/or scrubbing of the first lateral edge 153 or the second lateral edge 155 can reduce particles and unintended scratches at the lateral edges 153, 155 of the glass ribbon 104.

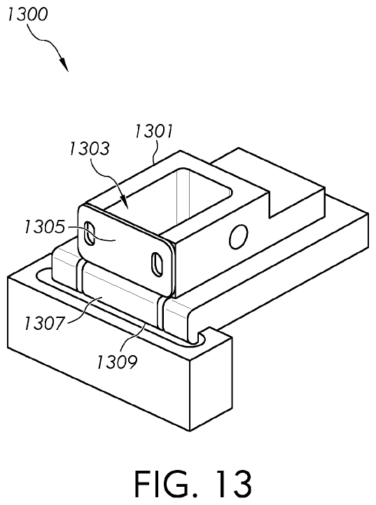

Referring to FIG. 13, further embodiments of a lateral applicator 1300 of the first row of lateral applicators 335 and/or the second row of lateral applicators 337 is illustrated. In some embodiments, the lateral applicator 1300 can comprise a body 1301. The body 1301 can comprise a reservoir 1303 that can store the lateral treatment liquid. In some embodiments, the lateral applicator 1300 may comprise a source that can deliver the lateral treatment liquid to the reservoir 1303. In some embodiments, one side of the reservoir 1303 may be bordered by a gate 1305. As illustrated in FIG. 13, the gate 1305 may be in a closed position, but may be movable to an opened position. When the gate is in the closed position, the lateral treatment liquid may be contained within the reservoir 1303 and limited from flowing out of the reservoir 1303. The gate 1305 may be moved to the opened position, such as by lifting the gate, whereupon the lateral treatment liquid exits the reservoir 1303 and flows past the gate 1305.

In some embodiments, the lateral applicator 1300 can comprise a lateral surface 1307 facing the lateral direction 347 extending across the travel direction 305 and parallel to the first surface 319 of the upstream applicator 309 and/or the second surface 329 of the downstream applicator 311. The lateral surface 1307 can be positioned below the gate 1305 and downstream from the reservoir 1303. When the gate 1305 is in the opened position, the lateral treatment liquid can flow downwardly along the lateral surface 1307. The lateral applicator 1300 can comprise a collection reservoir 1309 that may be disposed below the lateral surface 1307. In some embodiments, the collection reservoir 1309 can comprise a bowl, a trough, or other receptacle that can receive the lateral treatment liquid from the lateral surface 1307. The collection reservoir 1309 can recapture at least some of the lateral treatment liquid that flows down the lateral surface 1307. For example, as the lateral treatment liquid flows down the lateral surface 1307, at least some of the lateral treatment liquid falls into the collection reservoir 1309. In some embodiments, the lateral applicator 1300 can comprise a pump that can recirculate the collected lateral treatment liquid from the collection reservoir 1309 back to the reservoir 1303.

In some embodiments, applying the lateral treatment liquid to one or more of the first lateral edge 153 or the second lateral edge 155 can comprise guiding the lateral treatment liquid to flow along the lateral surface 1307 facing the lateral direction 347 extending across the travel direction 305. For example, as the glass ribbon 104 moves in the travel direction, the first lateral edge 153 or the second lateral edge 155 may be in close proximity to the lateral surface 1307. In some embodiments, the glass ribbon 104 can be directed along the travel path 307 such that the first lateral edge 153 or the second lateral edge 155 can pass through the lateral treatment liquid flowing down the lateral surface 1307. Lateral treatment liquid applied to the first lateral edge 153 or the second lateral edge 155 by the lateral surface 1307 can reduce particles, such as adhered glass particles, at the first lateral edge 153 or the second lateral edge 155.

In some embodiments of the disclosure, the glass treatment apparatus 301 can provide for improved treatment of the edges 153, 155, 312, 321 of the glass ribbon 104. For example, rather than submerging the glass ribbon 104 in a treatment liquid, the glass treatment apparatus 301 allows for localized treating of the glass ribbon 104. That is, the applicators 309, 311, 333 can treat the edges 153, 155, 312, 321 of the glass ribbon 104 while the central portion 152 of the glass ribbon 104 may not be treated. In these embodiments, the applicators 309, 311, 333 can apply a treatment liquid to the edges 153, 155, 312, 321 and/or can scrub the edges, thus reducing unwanted glass particles that may have accumulated along the edges 153, 155, 312, 321. In some embodiments, the various treatment liquids can be different treatment liquids, such that one treatment liquid may be applied to one edge 153, 155, 312, 321, while another, different, treatment liquid may be applies to a different edge 153, 155, 312, 321.

It will be appreciated that, as used herein, a glass sheet may be a type of the glass ribbon 104. For example, in some embodiments, the glass ribbon 104 can comprise a coiled length of glass ribbon on a storage roll, a glass ribbon in process (e.g., when the glass ribbon is continually formed), or when the glass ribbon 104 is cut into portions of glass ribbon comprising a glass sheet. In this way, a portion of the glass ribbon 104 may be a glass sheet. In some embodiments, one or more of the edges 153, 155, 312, 321 of the glass ribbon 104 can be treated with the treatment liquid before, during, or after the portion of the glass ribbon 104 has been cut. For example, in some embodiments, the lateral applicators 333, 1200, 1300 can treat the lateral edges 153, 155 of the glass ribbon 104 prior to cutting of the glass ribbon 104 (e.g., as part of an in-line process) into a portion of the glass ribbon 104 (e.g., a glass sheet). In these embodiments, the lateral edges 153, 155 of the glass ribbon 104 can be treated before and/or in the absence of treatment of the upstream edge 312 and the downstream edge 321, with the lateral edges 153, 155 being treated after the edge beads have been removed. In addition or in the alternative, the upstream applicator 309 can treat the upstream edge 312 of the glass ribbon 104 prior to cutting of the glass ribbon 104 (e.g., as part of an in-line process) into a portion of the glass ribbon 104 (e.g., a glass sheet). In some embodiments, a glass sheet (e.g., illustrated in FIGS. 3-10) may be a portion or a type of glass ribbon 104, and may be treated with the treatment liquid as described herein.

Accordingly, the following nonlimiting embodiments are exemplary of the present disclosure.

Embodiment 1. A glass treatment apparatus can comprise an upstream applicator comprising a first surface movable between a first upstream position where the first surface is within a travel path of the glass treatment apparatus while extending across a travel direction of the travel path and facing a downstream direction opposite the travel direction, and a second upstream position where the first surface is outside the travel path.

Embodiment 2. The glass treatment apparatus of embodiment 1, wherein the first surface of the upstream applicator can be rotatable between the first upstream position and the second upstream position.

Embodiment 3. The glass treatment apparatus of any one of embodiments 1-2, further comprising a downstream applicator comprising a second surface that can be movable between a first downstream position where the second surface is within the travel path while extending across the travel direction of the travel path and facing an upstream direction in the travel direction, and a second downstream position that is outside the travel path.

Embodiment 4. The glass treatment apparatus of embodiment 3, wherein the second surface of the downstream applicator can be rotatable between the first downstream position and the second downstream position.

Embodiment 5. The glass treatment apparatus of any one of embodiments 1-4, wherein the first surface of the upstream applicator can be parallel with the second surface of the downstream applicator.

Embodiment 6. A glass treatment apparatus comprising a downstream applicator comprising a second surface that can be movable between a first downstream position where the second surface is within a travel path of the glass treatment apparatus while extending across a travel direction of the travel path and facing an upstream direction in the travel direction, and a second downstream position that is outside the travel path.

Embodiment 7. The glass treatment apparatus of embodiment 6, wherein the second surface of the downstream applicator can be rotatable between the first downstream position and the second downstream position.

Embodiment 8. The glass treatment apparatus of any one of embodiments 1-7, further comprising a lateral applicator.

Embodiment 9. The glass treatment apparatus of embodiment 8, wherein the lateral applicator can comprise a channel facing a lateral direction extending across the travel direction.

Embodiment 10. The glass treatment apparatus of embodiment 8, wherein the lateral applicator can comprise a lateral surface rotatable about a rotation axis.

Embodiment 11. The glass treatment apparatus of embodiment 8, wherein the lateral applicator can comprise a lateral surface facing a lateral direction extending across the travel direction and parallel to the second surface of the downstream applicator.

Embodiment 12. A method of treating a glass ribbon with the glass treatment apparatus of any one of embodiments 1 and 3. The method can comprise moving a glass ribbon along the travel direction of the travel path. The method can further comprise applying an upstream treatment liquid to an upstream edge of the glass ribbon by engaging the upstream edge with the first surface of the upstream applicator positioned in the first upstream position. The method can further comprise moving the upstream applicator to the second upstream position. The method can further comprise continuing to move the glass ribbon along the travel direction of the travel path without engaging the glass ribbon with the first surface of the upstream applicator while the upstream applicator is positioned in the second upstream position.

Embodiment 13. The method of embodiment 12, further comprising rotating the first surface from the second upstream position to the first upstream position during or prior to the applying the upstream treatment liquid.

Embodiment 14. The method of any one of embodiments 12-13, further comprising rotating the first surface of the upstream applicator from the first upstream position to the second upstream position during the moving the upstream applicator to the second upstream position.

Embodiment 15. The method of any one of embodiments 12-14 further comprising applying a downstream treatment liquid to a downstream edge of the glass ribbon by engaging the downstream edge with the second surface of the downstream applicator positioned in the first downstream position.

Embodiment 16. The method of embodiment 15, further comprising moving the second surface from the second downstream position to the first downstream position during or prior to the applying the downstream treatment liquid.

Embodiment 17. The method of embodiment 16, further comprising rotating the second surface of the downstream applicator from the second downstream position to the first downstream position during the moving the second surface from the second downstream position to the first downstream position.

Embodiment 18. The method of any one of embodiments 16-17, wherein the moving the second surface from the second downstream position to the first downstream position can cause the upstream edge of the glass ribbon to engage the first surface of the upstream applicator positioned in the first upstream position such that the first surface applies the upstream treatment liquid to the upstream edge of the glass ribbon.

Embodiment 19. A method of treating a glass ribbon with the glass treatment apparatus can comprise applying a downstream treatment liquid to a downstream edge of the glass ribbon by engaging the downstream edge with the second surface of the downstream applicator positioned in the first downstream position.

Embodiment 20. The method of embodiment 19, further comprising moving the second surface from the second downstream position to the first downstream position during or prior to the applying the downstream treatment liquid.

Embodiment 21. The method of embodiment 20, further comprising rotating the second surface of the downstream applicator from the second downstream position to the first downstream position during the moving the second surface from the second downstream position to the first downstream position.

Embodiment 22. The method of any one of embodiments 12-21, further comprising applying a lateral treatment liquid to one or more of a first lateral edge or a second lateral edge while moving the glass ribbon in the travel direction.

Embodiment 23. The method of embodiment 22, wherein the applying the lateral treatment liquid to one or more of the first lateral edge or the second lateral edge can comprise guiding the lateral treatment liquid to flow along a lateral surface facing a lateral direction extending across the travel direction and parallel to the second surface of the downstream applicator.

Embodiment 24. The method of any one of embodiments 12-23, wherein one or more of the upstream treatment liquid, the downstream treatment liquid, or the lateral treatment liquid can comprise one or more of hydrofluoric acid or hydrochloric acid.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof shall be construed as synonymous and open-ended, unless otherwise indicated.

It should be understood that while various embodiments have been described in detail with respect to certain illustrative and specific embodiments thereof, the present disclosure should not be considered limited to such, as numerous modifications and combinations of the disclosed features are possible without departing from the scope of the following claims.

1. A glass treatment apparatus comprising:
an upstream applicator comprising a first surface movable between a first upstream position where the first surface is within a travel path of the glass treatment apparatus while extending across a travel direction of the travel path and facing a downstream direction opposite the travel direction, and a second upstream position where the first surface is outside the travel path.

2. The glass treatment apparatus of claim 1, wherein the first surface of the upstream applicator is rotatable between the first upstream position and the second upstream position.

3. The glass treatment apparatus of claim 1, further comprising a downstream applicator comprising a second surface movable between a first downstream position where the second surface is within the travel path while extending across the travel direction of the travel path and facing an upstream direction in the travel direction, and a second downstream position that is outside the travel path.

4. The glass treatment apparatus of claim 3, wherein the second surface of the downstream applicator is rotatable between the first downstream position and the second downstream position.

5. The glass treatment apparatus of claim 1, wherein the first surface of the upstream applicator is parallel with the second surface of the downstream applicator.

6. A glass treatment apparatus comprising:
a downstream applicator comprising a second surface movable between a first downstream position where the second surface is within a travel path of the glass treatment apparatus while extending across a travel direction of the travel path and facing an upstream direction in the travel direction, and a second downstream position that is outside the travel path.

7. The glass treatment apparatus of claim 6, wherein the second surface of the downstream applicator is rotatable between the first downstream position and the second downstream position.

8. The glass treatment apparatus of claim 1, further comprising a lateral applicator.

9. The glass treatment apparatus of claim 8, wherein the lateral applicator comprises a channel facing a lateral direction extending across the travel direction.

10. The glass treatment apparatus of claim 8, wherein the lateral applicator comprises a lateral surface rotatable about a rotation axis.

11. The glass treatment apparatus of claim 8, wherein the lateral applicator comprises a lateral surface facing a lateral direction extending across the travel direction and parallel to the second surface of the downstream applicator.

12. A method of treating a glass ribbon with the glass treatment apparatus of claim 1, comprising:
moving a glass ribbon along the travel direction of the travel path;
applying an upstream treatment liquid to an upstream edge of the glass ribbon by engaging the upstream edge with the first surface of the upstream applicator positioned in the first upstream position;
moving the upstream applicator to the second upstream position; and
continuing to move the glass ribbon along the travel direction of the travel path without engaging the glass ribbon with the first surface of the upstream applicator while the upstream applicator is positioned in the second upstream position.

13. The method of claim 12, further comprising rotating the first surface from the second upstream position to the first upstream position during or prior to the applying the upstream treatment liquid.

14. The method of claim 12, further comprising rotating the first surface of the upstream applicator from the first upstream position to the second upstream position during the moving the upstream applicator to the second upstream position.

15. The method of claim 12, further comprising applying a downstream treatment liquid to a downstream edge of the glass ribbon by engaging the downstream edge with the second surface of the downstream applicator positioned in the first downstream position.

16. The method of claim 15, further comprising moving the second surface from the second downstream position to the first downstream position during or prior to the applying the downstream treatment liquid.

17. The method of claim 16, further comprising rotating the second surface of the downstream applicator from the second downstream position to the first downstream position during the moving the second surface from the second downstream position to the first downstream position.

18. The method of claim 16, wherein the moving the second surface from the second downstream position to the first downstream position causes the upstream edge of the glass ribbon to engage the first surface of the upstream applicator positioned in the first upstream position such that the first surface applies the upstream treatment liquid to the upstream edge of the glass ribbon.

19. A method of treating a glass ribbon with the glass treatment apparatus of claim 6, comprising:
applying a downstream treatment liquid to a downstream edge of the glass ribbon by engaging the downstream edge with the second surface of the downstream applicator positioned in the first downstream position.

20. The method of claim 19, further comprising moving the second surface from the second downstream position to the first downstream position during or prior to the applying the downstream treatment liquid.

21. The method of claim 20, further comprising rotating the second surface of the downstream applicator from the second downstream position to the first downstream position during the moving the second surface from the second downstream position to the first downstream position.

22. The method of claim 12, further comprising applying a lateral treatment liquid to one or more of a first lateral edge or a second lateral edge while moving the glass ribbon in the travel direction.

23. The method of claim 22, wherein the applying the lateral treatment liquid to one or more of the first lateral edge or the second lateral edge comprises guiding the lateral treatment liquid to flow along a lateral surface facing a lateral direction extending across the travel direction and parallel to the second surface of the downstream applicator.

24. The method of claim 12, wherein one or more of the upstream treatment liquid, the downstream treatment liquid, or the lateral treatment liquid comprises one or more of hydrofluoric acid or hydrochloric acid.
